(19) United States
(12) Patent Application Publication
(10) Pub. No.: US 2012/0250665 A1
(43) Pub. Date: Oct. 4, 2012

(54) Method and system for maintaining concurrent membership in multiple networks from a single wireless modem

(76) Inventor: Daniel J. Park, Beaverton, OR (US)

(21) Appl. No.: 13/065,801

(22) Filed: Mar. 30, 2011

(51) Int. Cl. H04W 84/02

(52) U.S. Cl. 370/338

(57) ABSTRACT

Method and system for maintaining concurrent membership in multiple networks from a single wireless modem on a wireless networking device. The device time-multiplexes between the networks according to time slots allocated to each network that are shorter than the membership timeout period for the other network. Moreover, whenever the device switches between the networks, the device resets the modem and rejoins the other network using configuration information stored in a nonvolatile memory when the network being rejoined was previously quit. Each network remains unaware of the device's membership in the other network and regards the absence of transmission from the device during the time slot allocated to the other network as a temporary loss of radio contact rather than a membership termination event. The invention enables a single-modem wireless networking device to maintain concurrent ZigBee sessions on a smart energy network and a home automation network.

### BACKGROUND OF THE INVENTION

The present invention relates to wireless networking and more particularly to maintaining concurrent membership in multiple networks from a single wireless modem on a wireless networking device.

ZigBee is a suite of communication protocols based on the IEEE 802.15.4 standard that use low-power digital radios for low-rate wireless networking.

ZigBee is often deployed at the residential edges of smart energy networks which interconnect large numbers of distributed energy generation and storage devices and that manage electrical power down to the residential level. A ZigBee device that is a member of a smart energy network can receive information from the network, such as grid electricity pricing, usage and events.

ZigBee is also commonly used in home automation networks that provide automated control of household devices. A ZigBee device that is a member of home automation network may transmit information on the ZigBee network in order to control household devices such as lights, thermostats and refrigerators.

There are situations where it would be desirable to have a single-modem ZigBee device belong to a smart energy network and a home automation network at the same time. For example, it might be useful to have a ZigBee device receive real-time grid electricity pricing or usage information from a smart energy network via a ZigBee enabled electric service meter and apply the information to control household devices in a home automation network. However, maintaining concurrent membership in a smart energy ZigBee network and home automation ZigBee network from a single wireless modem using conventional means is oftentimes not feasible due to security restrictions imposed by smart energy network operators (e.g., public utilities) that prohibit certain household devices from belonging to the smart energy network. While these security restrictions might be worked-around by adding a second modem to the ZigBee device and having the ZigBee device join the smart energy network via the first modem and the home automation network via the second modem, installing a second modem on the ZigBee device would add cost and complexity.

### SUMMARY OF THE INVENTION

The present invention provides a method and system for maintaining concurrent membership in multiple networks from a single wireless modem on a wireless networking device. The device time-multiplexes between the networks during time periods allocated to each network that are shorter than the membership timeout period for the other network. Moreover, whenever the device switches between the networks, the device resets the modem and rejoins the other network using configuration information stored in a nonvolatile memory when the network being rejoined was previously quit. Each network remains unaware of the device's membership in the other network and regards the absence of transmission from the device during the time period allocated to the other network as a temporary loss of radio contact rather than a membership termination event. In one application, the invention enables a single-modem wireless networking device to maintain concurrent ZigBee sessions on a smart energy network and a home automation network.

In one aspect of the invention, a method performed by a wireless networking device for maintaining concurrent membership in multiple networks from a single wireless modem comprises the steps of suspending transmission on a first network; resetting the modem in a first instance; rejoining a second network; suspending transmission on the second network in response to expiration of an operating interval for the second network selected to be shorter than a membership timeout period for the first network; resetting the modem in a second instance; and rejoining the first network.

In some embodiments, the first resetting step comprises accessing a pointer to a location in a nonvolatile memory where configuration information for the second network is stored, and the second resetting step comprises accessing a pointer to a location in the nonvolatile memory where configuration information for the first network is stored.

In some embodiments, the first rejoining step comprises loading from a nonvolatile memory configuration information for the second network, and the second rejoining step comprises loading from the nonvolatile memory configuration information for the first network.

In some embodiments, the configuration information includes an encryption key.

In some embodiments, the configuration information further includes a radio channel identifier, a device identifier or a short network address.

In some embodiments, the nonvolatile memory resides on the modem.

In some embodiments, the operating interval for the second network is selected to be shorter than the membership timeout period of the first network by at least two modem reset times.

In some embodiments, the operating interval for the second network is further selected to expire in response to detecting that a predetermined minimum amount of time has elapsed since the second network was rejoined, that no application data are awaiting transmission on the second network and that application data are awaiting transmission on the first network.

In some embodiments, the method further comprises the steps of suspending, by the device, transmission on the first network in response to expiration of an operating interval for the first network selected to be shorter than a membership timeout period for the second network, resetting the modem in a third instance, and rejoining the second network.

In some embodiments, the modem is ZigBee compliant.

In some embodiments, the first network is a smart energy network and the second network is a home automation network.

In another aspect of the invention, a wireless networking device comprises a processor; and a wireless modem communicatively coupled with the processor, wherein under control of the processor the device is adapted to transmit via the modem on a first network and on a second network, and wherein the modem is adapted to suspend transmission on the first network, reset in a first instance, rejoin the second network, suspend transmission on the second network after an operating interval for the second network selected to be shorter than a membership timeout period for the first network, reset in a second instance, and rejoin the first network.

These and other aspects of the invention will be better understood by reference to the following detailed description taken in conjunction with the drawings that are briefly described below. Of course, the invention is defined by the appended claims.

### BRIEF DESCRIPTION OF THE DRAWINGS

FIG. 1 shows a wireless communication system in which the invention is operative in some embodiments.

FIG. 2 shows the ZigBee device of FIG. 1 in greater detail.

FIGS. 3A and 3B show a method performed by the ZigBee device of FIG. 1 for maintaining concurrent membership in multiple networks in some embodiments of the invention.

### DETAILED DESCRIPTION OF A PREFERRED EMBODIMENT

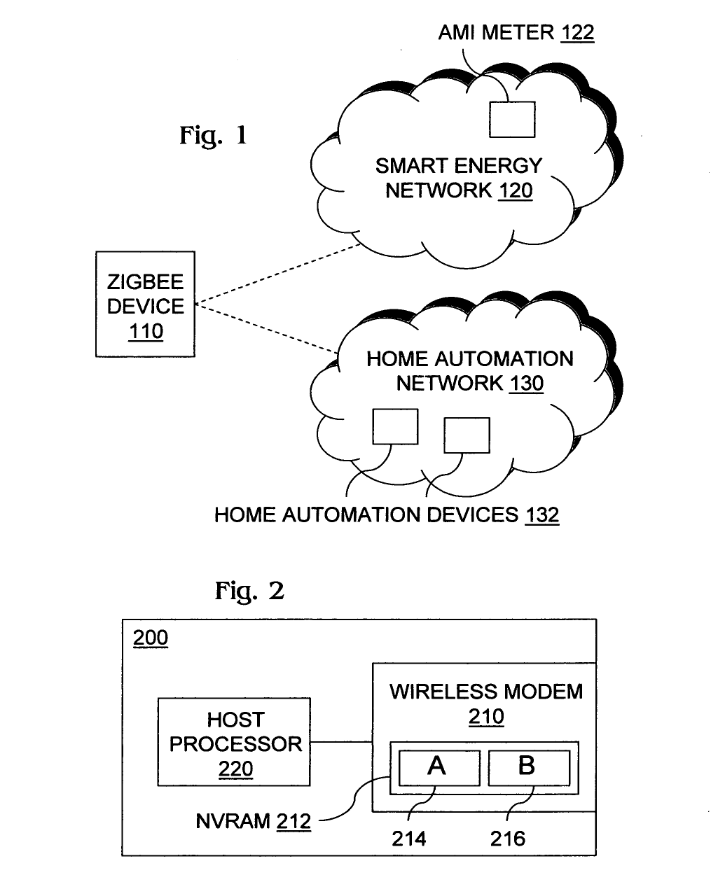

FIG. 1 shows a wireless communication system in which the invention is operative in some embodiments. The communication system includes a ZigBee device 110 having a first wireless connection to a smart energy network 120 and a second wireless connection to a home automation network 130.

ZigBee device 110 is a wireless networking device having a wireless modem that is ZigBee compliant. ZigBee device 110 maintains concurrent membership in smart energy network 120 and home automation network 130 from a single modem by performing a method for maintaining concurrent membership on multiple networks. In the method, ZigBee device 110 time-multiplexes between networks 120, 130 during time periods allocated to each network that are shorter than the membership timeout period for the other network. Moreover, whenever ZigBee device 110 switches between networks 120, 130, ZigBee device 110 resets its modem and rejoins the other network using configuration information stored in a nonvolatile memory when the network being rejoined was previously quit. Networks 120, 130 remain unaware of the membership by ZigBee device 110 in the other network and regard the absence of transmission from ZigBee device 110 during the time period allocated to the other network as a temporary loss of radio contact rather than a membership termination event.

Smart energy network 120 is a communication network that includes a large number of interconnected distributed energy generation and storage devices and manages electrical power down to the residential level. Smart energy network 120 has an advanced metering infrastructure meter 122 that transmits real-time grid information, such as grid electricity pricing, usage and events, to member devices, such as ZigBee device 110.

Home automation network 130 is a communication network that includes interconnected household devices 132, such as lights, a thermostat and a refrigerator, that are remotely controllable by one or more member devices, such as ZigBee device 110. Household devices 132 may be controlled based on any number of factors, such as time of day, day of week, grid electricity pricing, grid electricity usage or grid events.

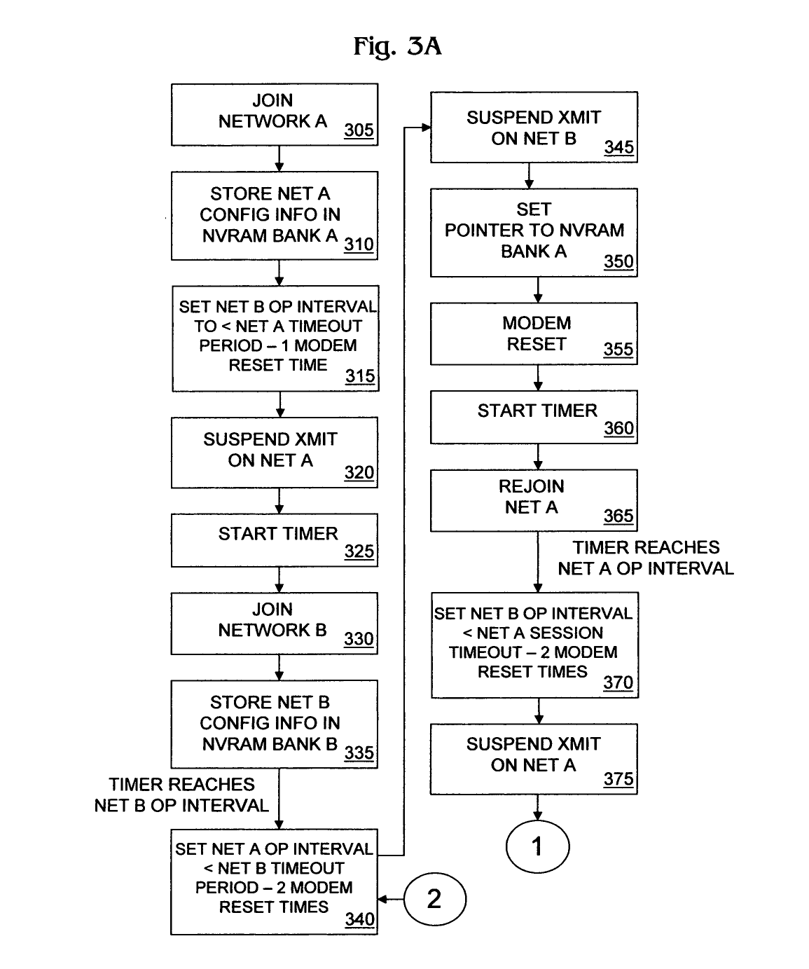

FIG. 2 shows ZigBee device 110 in greater detail. ZigBee device 110 has a wireless modem 210 that is communicatively coupled to a host processor 220 via one or more wired connections, such as serial RS232, universal serial bus (USB) or serial peripheral interface (SPI) connections. ZigBee device 110, under the control of processor 220 executing software instructions, conducts application data flows via wireless modem 210 on smart energy network 120 and home automation network 130. Wireless modem 210, which may rely on custom logic, a processor executing software instructions, or a combination of custom and general purpose logic to perform the various functions attributed to wireless modem 210 herein, suspends transmission of application data on networks 120, 130, resets itself, and rejoins networks 120, 130 in a manner that allows ZigBee device 110 to maintain concurrent membership in networks 120, 130 without networks 120, 130 becoming aware of the membership in the other network, and without the need to deploy a second wireless modem on ZigBee device 110. Wireless modem 210 has a nonvolatile random access memory (NVRAM) 212 with memory banks 214, 216. Wireless modem 210 stores configuration information for networks 120, 130 to memory banks 214, 216 and loads configuration information for networks 120, 130 from memory banks 214, 216 to facilitate in maintaining the concurrent memberships. Notably, storing the configuration information in NVRAM on wireless modem 210 provides added security as the configuration information is not easily accessible by higher-level software (e.g., malicious code executed by processor 220).

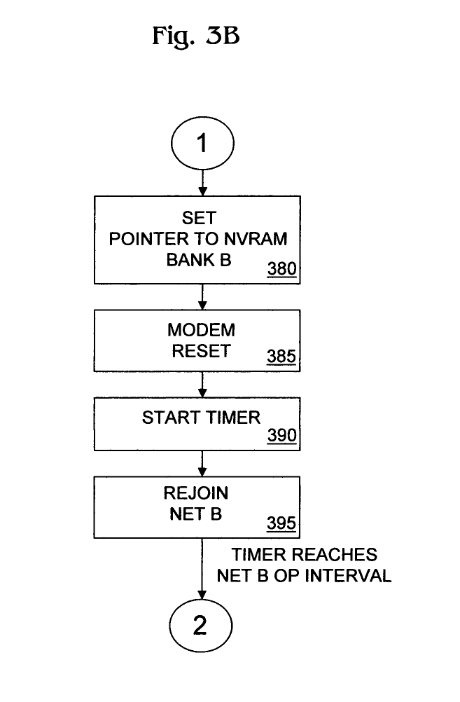

FIGS. 3A and 3B show a method for maintaining concurrent membership in two networks A and B in some embodiments of the invention. While networks A and B may be of various types, the method will be described in conjunction with FIGS. 1 and 2 wherein Network A is smart energy network 120 and Network B is home automation network 130, and wherein the method is performed by ZigBee device 110 to maintain concurrent membership in smart energy network 120 and home automation network 130.

First, ZigBee device 110 joins smart energy network 120 (Network A) (305). NVRAM 212 is configured with information sufficient to enable wireless modem 210 to contact smart energy network 120 and initiate a join procedure, resulting in membership of ZigBee device 110 being established via wireless modem 210 in smart energy network 120. One or more application data flows between ZigBee device 110 and smart energy network 120 commence.

Next, ZigBee device 110 stores configuration information for smart energy network 120 in memory bank 214 (310). Wireless modem 210 stores the configuration information, which may include network parameters, such as a radio channel identifier, a device identifier and encryption keys, and personality values, such as a short network address.

Next, ZigBee device 110 sets an operating interval for home automation network 130 (Network B) to a time shorter than a membership timeout period for smart energy network 120 by at least one wireless modem reset time (315). The membership timeout period for smart energy network 120 is the time allowed to elapse between transmissions by ZigBee device 110 on smart energy network 120 before membership in smart energy network 120 is rescinded for inactivity. The modem reset time is the time that it takes wireless modem 210 to reset. The operating interval for home automation network 130 may be preconfigured in NVRAM 210. Alternatively, NVRAM 212 may be configured with information (e.g., timeout period for smart energy network 120 and modem reset time) sufficient to enable wireless modem 210 to calculate the operating interval for home automation network 130.

Next, ZigBee device 110 suspends transmission on smart energy network 120 (320). To effect the suspension, wireless modem 210 prevents application and control data from being transmitted to smart energy network 120. Application and control data awaiting transmission to smart energy network 120 may be queued until the suspension is lifted or discarded.

Next, ZigBee device 110 starts a timer (325). The timer will run until the operating interval for home automation network 130 elapses. Transmissions on home automation network 130 will be suspended in response to expiration of the operating interval for home automation network 130.

Next, ZigBee device 110 joins home automation network 130 (330). NVRAM 212 is configured with information sufficient to enable wireless modem 210 to contact home automation network 130 and initiate a join procedure, resulting in membership of ZigBee device 110 being established via wireless modem 210 in home automation network 130. One or more application data flows between ZigBee device 110 and home automation network 130 commence.

Next, ZigBee device 110 stores configuration information for home automation network 130 in memory bank 216 (335). Wireless modem 210 stores the configuration information, which may include network parameters, such as a radio channel identifier, a device identifier and encryption keys, and personality values, such as a short network address.

The method then waits until the timer started in Step 325 reaches the operating interval set for home automation network 130 in Step 315.

At that point, ZigBee device 110 sets an operating interval for smart energy network 120 to a time shorter than a membership timeout period for home automation network 130 by at least two wireless modem reset times (340). The membership timeout period for home automation network 130 is the time allowed to elapse between transmissions by ZigBee device 110 on home automation network 130 before membership in home automation network 130 is rescinded for inactivity. The modem reset time is the time that it takes wireless modem 210 to reset. The operating interval for smart energy network 120 may be preconfigured in NVRAM 210. Alternatively, NVRAM 212 may be configured with information (e.g., timeout period for home automation network 130 and modem reset time) sufficient to enable wireless modem 210 to calculate the operating interval for smart energy network 120.

Next, ZigBee device 110 suspends transmission on home automation network 130 (345). To effect the suspension, wireless modem 210 prevents application and control data from being transmitted to home automation network 130. Application and control data awaiting transmission may be queued until the suspension is lifted or discarded.

Next, ZigBee device 110 sets a pointer to memory bank 214 (350). This pointer will cause wireless modem 210, during a reset sequence that follows, to load configuration information from memory bank 214 that allows ZigBee device 110 to rejoin smart energy network 120 in a well-known state. The pointer may be stored in a known location in NVRAM 212 accessed by wireless modem 210 during the reset sequence, or provided on hardware pin to wireless modem 210 during the reset sequence, or provided in a communication signal received by wireless modem 210 during the reset sequence, by way of example.

Next, ZigBee device 110 resets wireless modem 210 (355). During the reset sequence, wireless modem 210 loads configuration information from memory bank 214.

Next, ZigBee device 110 starts a timer (360). The timer will run until the operating interval for smart energy network 120 elapses. Transmission on smart energy network 120 will be suspended in response to expiration of the operating interval for smart energy network 120.

Next, ZigBee device 110 rejoins smart energy network 120 (365). Using the pointer set in Step 350, wireless modem 120 loads configuration information from memory bank 214 that allows ZigBee device 110 to rejoin smart energy network 120 in a well-known state. Application data flows between ZigBee device 110 and smart energy network 120 resume. Notably, the devices on smart energy network 120 will be unaware of the membership by ZigBee device 110 in home automation network 130 and may regard the absence of transmission from ZigBee device 110 during the time slot allocated to home automation network 130 as a temporary loss of radio contact rather than a membership termination event. The temporary loss of contact will be compensated with retransmission of messages lost or delayed during the time slot allocated to home automation network 130.

The method then waits until the timer started in Step 360 reaches the operating interval set for smart energy network 120 in Step 340.

At that point, ZigBee device 110 sets an operating interval for home automation network 130 to a time shorter than a membership timeout period for smart energy network 120 by at least two wireless modem reset times (370). The membership timeout period for smart energy network 120 is the time allowed to elapse between transmissions by ZigBee device 110 on smart energy network 120 before membership in smart energy network 120 is rescinded for inactivity. The modem reset time is the time that it takes wireless modem 210 to reset. The operating interval for home automation network 130 may be preconfigured in NVRAM 210. Alternatively, NVRAM 212 may be configured with information (e.g., timeout period for smart energy network 120 and modem reset time) sufficient to enable wireless modem 210 to calculate the operating interval for home automation network 130.

Next, ZigBee device 110 suspends transmission on smart energy network 120 (375). To effect the suspension, wireless modem 210 prevents application and control data from being transmitted to smart energy network 120. Application and control data awaiting transmission may be queued until the suspension is lifted or discarded.

Next, ZigBee device 110 sets a pointer to memory bank 216 (380). This pointer will cause wireless modem 210, during a reset sequence that follows, to load configuration information from memory bank 216 that allows ZigBee device 110 to rejoin home automation network 130 in a well-known state. The pointer may be stored in a known location in NVRAM 212 accessed by wireless modem 210 during the reset sequence, or provided on hardware pin to wireless modem 210 during the reset sequence, or provided in a communication signal received by wireless modem 210 during the reset sequence, by way of example.

Next, ZigBee device 110 resets wireless modem 210 (385). During the reset sequence, wireless modem 210 loads configuration information from memory bank 216.

Next, ZigBee device 110 starts a timer (390). The timer will run until the operating interval for home automation network 130 elapses, at which point transmissions on home automation network 130 will be suspended.

Next, ZigBee device 110 rejoins home automation network (395). Using the pointer set in Step 380, wireless modem 120 loads configuration information from memory bank 216 that allows ZigBee device 110 to rejoin home automation network 130 in a well-known state. Application data flows between ZigBee device 110 and home automation network 130 recommence. Notably, the devices on home automation network 130 will be unaware of the membership by ZigBee device 110 in smart energy network 120 and may regard the absence of transmission from ZigBee device 110 during the time slot allocated to smart energy network 120 as a temporary loss of radio contact rather than a membership termination event. The temporary loss of contact will be compensated with retransmission of messages lost or delayed during the time slot allocated to smart energy network 120.

The method then waits until the timer started in Step 390 reaches the operating interval set for home automation network 130 in Step 370.

At that point, the process returns to Step 340 and Steps 340-395 are reperformed in a continuous loop.

It will be appreciated by those of ordinary skill in the art that the invention can be embodied in other specific forms without departing from the spirit or essential character hereof. For example, in some embodiments, the operating interval of the current network may be adapted to expire early (e.g., before the membership timeout period of the suspended network is approached), prompting early suspension of the current network and early lifting of the suspension on the suspended network, when wireless modem 210 detects the following conditions: (i) a predetermined minimum amount of time has elapsed since the current network was rejoined; (ii) no application data are awaiting transmission on the current network; and (iii) application data are awaiting transmission on the suspended network.

The present description is thus considered in all respects to be illustrative and not restrictive. The scope of the invention is indicated by the appended claims, and all changes that come with in the meaning and range of equivalents thereof are intended to be embraced therein.

What is claimed is:

1. A method performed by a wireless networking device for maintaining concurrent membership in multiple networks from a single modem, comprising the steps of:
suspending, by the device, transmission on a first network;
resetting, by the device, the modem in a first instance;
rejoining, by the device, a second network;
suspending, by the device, transmission on the second network in response to expiration of an operating interval for the second network selected to be shorter than a membership timeout period for the first network;
resetting, by the device, the modem in a second instance; and
rejoining, by the device, the first network.

2. The method of claim 1, wherein the first resetting step comprises accessing a pointer to a location in a nonvolatile memory where configuration information for the second network is stored, and the second resetting step comprises accessing a pointer to a location in the nonvolatile memory where configuration information for the first network is stored.

3. The method of claim 1, wherein the first rejoining step comprises loading from a nonvolatile memory configuration information for the second network, and the second rejoining step comprises loading from the nonvolatile memory configuration information for the first network.

4. The method of claim 3, wherein the configuration information includes an encryption key.

5. The method of claim 4, wherein the configuration information further includes a radio channel identifier, a device identifier or a short network address.

6. The method of claim 3, wherein the nonvolatile memory resides on the modem.

7. The method of claim 1, wherein the operating interval for the second network is selected to be shorter than the membership timeout period of the first network by at least two modem reset times.

8. The method of claim 1, wherein the operating interval for the second network is further selected to expire in response to detecting that a predetermined minimum amount of time has elapsed since the second network was rejoined, that no application data are awaiting transmission on the second network and that application data are awaiting transmission on the first network.

9. The method of claim 1, wherein the method further comprises the steps of suspending, by the device, transmission on the first network in response to expiration of an operating interval for the first network selected to be shorter than a membership timeout period for the second network, resetting the modem in a third instance, and rejoining the second network.

10. The method of claim 1, wherein the first network is a smart energy network, the second network is a home automation network and the modem is ZigBee compliant.

11. A wireless networking device, comprising:
a processor; and
a wireless modem communicatively coupled with the processor, wherein under control of the processor the device is adapted to transmit via the modem on a first network and on a second network, and wherein the modem is adapted to suspend transmission on the first network, reset in a first instance, rejoin the second network, suspend transmission on the second network after an operating interval for the second network selected to be shorter than a membership timeout period for the first network, reset in a second instance, and rejoin the first network.

12. The device of claim 11, wherein the modem is adapted to access a pointer to a location in a nonvolatile memory where configuration information for the second network is stored, and is adapted to access a pointer to a location in the nonvolatile memory where configuration information for the first network is stored.

13. The device of claim 11, wherein the modem is adapted to load from a nonvolatile memory configuration information for the second network, and is adapted to load the from the nonvolatile memory configuration information for the first network.

14. The device of claim 13, wherein the configuration information includes an encryption key.

15. The device of claim 14, wherein the configuration information further includes a radio channel identifier, a device identifier or a short network address.

16. The device of claim 13, wherein the nonvolatile memory resides on the modem.

17. The device of claim 11, wherein the operating interval for the second network is selected to be shorter than the membership timeout period of the first network by at least two modem reset times.

18. The device of claim 11, wherein the operating interval for the second network is further selected to expire in response to detecting that a predetermined minimum amount of time has elapsed since the second network was rejoined, that no application data are awaiting transmission on the second network and that application data are awaiting transmission on the first network.

19. The device of claim 11, wherein the modem is further adapted to suspend transmission on the first network in response to expiration of an operating interval for the first network selected to be shorter than a membership timeout period for the second network, reset in a third instance, and rejoin the second network.

20. The device of claim 11, wherein the first network is a smart energy network, the second network is a home automation network and the modem is ZigBee compliant.
